(19) United States
(12) Patent Application Publication
(10) Pub. No.: US 2013/0341507 A1
(43) Pub. Date: Dec. 26, 2013

(54) METHOD FOR ELECTROSTATIC CHARGING OF NON-CONDUCTING OBJECTS

(71) Applicant: Robert Fischer, Zevenaar (NL)

(72) Inventor: Robert Fischer, Zevenaar (NL)

(73) Assignee: ILLINOIS TOOL WORKS INC., Glenview, IL (US)

(21) Appl. No.: 13/825,455

(22) PCT Filed: Oct. 7, 2011
(86) PCT No.: PCT/US2011/055378

§ 371 Date: Sep. 10, 2013

(30) Foreign Application Priority Data
Oct. 8, 2010 (DE) 10 2010 047 781.8

(51) Int. Cl. H01T 19/00

(52) U.S. Cl. CPC H01T 19/00
USPC 250/325

(57) ABSTRACT

In a method for electrostatic charging of non-conducting objects by at least one electrode under control of a control device, an object to be electrostatically charged is brought into the effective range of the electrode. The control device is transferred into an idling state if no object to be electrostatically charged is present in the effective range of the electrode, and, in the idling state, an idling current is impressed into the electrode. The control device is transferred into a charging state if an object to be electrostatically charged is brought into the effective range of the electrode, and, in the charging state, a charging current different than the idling current is impressed into the electrode by the control device.

The invention relates to a method for electrostatic charging of non-conducting objects in accordance with the preamble of claim 1, to such a method according to a further teaching in accordance with the preamble of claim 9, and also to an apparatus for carrying out the above method in accordance with claim 10.

The change in the electrostatic charging state particularly of surfaces of non-conducting objects plays an important part in industrial manufacturing. So-called “ionizers” are regularly used in this case. Said ionizers are often equipped with electrodes composed of a multiplicity of electrode tips to which high voltage relative to ground or relative to a counterelectrode is applied. High voltage leads by way of a corona discharge to the formation of ionized air in the region of the electrode tips. The interaction of the ionized air with a surface of the non-conducting object in turn leads to electrostatic charging or discharging of said surface. Such corona ionizers are known from DE 195 20 260 A1 for example.

The targeted charging of surfaces of non-conducting objects can be utilized, for example, to eliminate an undesired charging state, in order to prevent an undesired electrostatic attraction force from arising.

Another application consists in utilizing the electrostatic attraction force between two differently charged objects in order to provisionally fix these objects against one another. Examples thereof are found in paper processing, in the production of plastic bags, and in the stacking of catalogs and brochures. This type of provisional fixing of objects is given a special emphasis in the present case, although this should not be understood to be restrictive.

The objects to be electrostatically charged are generally guided past the electrodes by means of a conveying system, the corresponding charging or discharging being performed at the same time.

The known method from which the invention proceeds is disclosed in DE 35 08 514 A1. The electrodes are connected to the high-voltage supply via a switch, wherein the switch is coupled to the conveying system, such that the switching processes are synchronized with the advance of the conveying system. Specifically, in a switching operation, high voltage is applied to the electrodes in the manner of a corona ionizer by means of a control device. The switch is actuated by a type of camshaft, which leads to a relatively complicated overall arrangement.

In another known method (EP 0 683 034 A2), for the purpose of switching the electrode voltage on and off, recourse is had to machine signals and to a timer. This, too, is likewise complicated to realize.

The invention addresses the problem of developing the known method in such a way that the targeted introduction of charges at a surface of a non-conducting object is optimized using simple means.

In the case of a method in accordance with the preamble of claim 1, the above problem is solved by means of the features of the characterizing part of claim 1.

Firstly, it should be pointed out that the term “charging” in the present case relates very generally to a targeted change in charge. Accordingly, this term encompasses not only the charging, but also the neutralizing or the discharging of surfaces of the non-conducting objects.

Further, it should be pointed out that, in accordance with the proposal, the object to be electrostatically charged can pass into the effective range of the electrode by means of its own movement. However, it is also conceivable that the electrode is moved for this purpose.

What is essential, then, is firstly the consideration that the control device assigned to the at least one electrode operates as current control. The realization of current control during the charging operation in question is very generally advantageous because the ion current can be set independently of ambient conditions and the wear situation of the at least one electrode. By virtue of the fact that a relatively low electrode voltage can be expected with the current control, it is anticipated that the formation of sparks at the electrode will be reduced.

By means of the control loop, the controlled variable, that is to say the actual electrode current flowing via the at least one electrode, is controlled with regard to a reference variable, that is to say a desired electrode current. The control device is regularly equipped with a controller that determines a manipulated variable, here the electrode voltage, from the difference between reference variable and controlled variable. The controlled system here forms the system between electrode and counterelectrode or between electrode and ground.

Furthermore, it is essential that the control device can be brought into an idling state and into a charging state.

In idling operation, if no object to be electrostatically charged is situated in the effective range of the electrode, the control device is transferred into the idling state and an idling current (desired electrode current) is impressed into the electrode. If an object to be electrostatically charged is then brought into the effective range of the electrode for the charging operation, the control device is automatically transferred into the charging state and a charging current (desired electrode current) different than the idling current is impressed into the electrode.

Depending on the design, the transfer of the control device between the idling state and the charging state as a reaction to the object movements above is associated with a certain temporal delay, but the latter is insignificant for the success in accordance with the proposal and is discussed in detail further below.

The proposed method makes it possible given a suitable design, to impress a certain current into the at least one electrode both in idling operation and in charging operation, without an excessive ion current arising during idling operation. Specifically, this would be associated with correspondingly high wear of the at least one electrode and with a high energy consumption.

Accordingly, in the particularly preferred configuration in accordance with claim 2, it is also provided that the absolute value of the charging current is greater than the absolute value of the idling current. By virtue of a comparatively low idling current being realized, advantageously the production of ozone, which is always associated with corona ionization, is also kept advantageously low.

The method in accordance with the proposal has a further advantage leading to a very considerable simplification of the apparatus that carries out the method. Here use is made of the fact that, in idling operation, a movement of an object to be electrostatically charged into the effective range of the electrode leads to a rise in the manipulated variable, here the electrode voltage, if the object is non-conducting. The rise in the electrode voltage is attributed to the fact that the control device, with an increase in the electrode voltage, will attempt to keep the electrode current at the respective desired electrode current. The change in the manipulated variable, here the electrode voltage, is now utilized in order to detect the movement of a non-conducting object into the effective range of the at least one electrode. For this purpose, a trigger device is provided, the mode of operation of which is the subject of claims 3 to 5. Sensors or the like for “activating” the at least one electrode can be dispensed with here.

It should be pointed out that the control device in accordance with the proposal can also be brought into further states. By way of example, it is conceivable for different charging states to be assumed depending on the type of object respectively to be charged. In this case, the type of object is preferably determined by the detection of the characteristic of the rise in the electrode voltage.

Furthermore, it is possible, in principle, for the control device to be transferred into a deactivated state in specific phases, in particular in a remote-controlled manner, in such a way that no current is impressed into the electrode. As indicated above, this deactivation can be effected in a remote-controlled manner by means of a superordinate controller or the like, or else manually.

According to a further teaching, which is likewise accorded independent importance, the above problem is solved by a method in accordance with the preamble of claim 9 by means of the features of the characterizing part of claim 9.

What is essential to the method according to the further teaching is very generally that a predetermined temporal deviation is utilized during control operation in order to transfer the control device into an idling state or into a charging state by means of a trigger device. This further teaching therefore concerns the consideration of utilizing the at least one electrode as it were as a sensor for detecting a non-conducting object in the range of action of the at least one electrode. Separate sensors for detecting such an object can accordingly be dispensed with.

According to a further teaching, which is likewise accorded independent importance, an apparatus for carrying out one of the above methods is claimed in accordance with claim 10. Reference should be made to the entirety of the explanations concerning the methods in accordance with the proposal.

The invention is explained in greater detail below with reference to a drawing, which merely illustrates one exemplary embodiment. In the drawing:

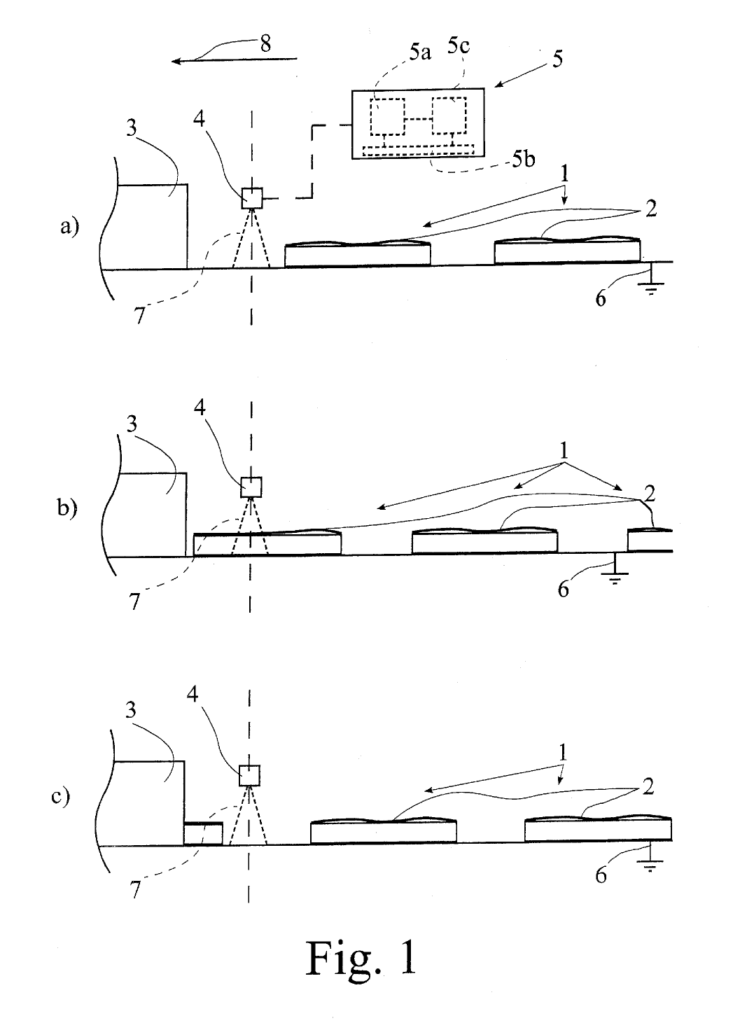

FIG. 1 shows an apparatus for carrying out the methods in accordance with the proposal a) in a first state, b) in a second state and c) in a third state,

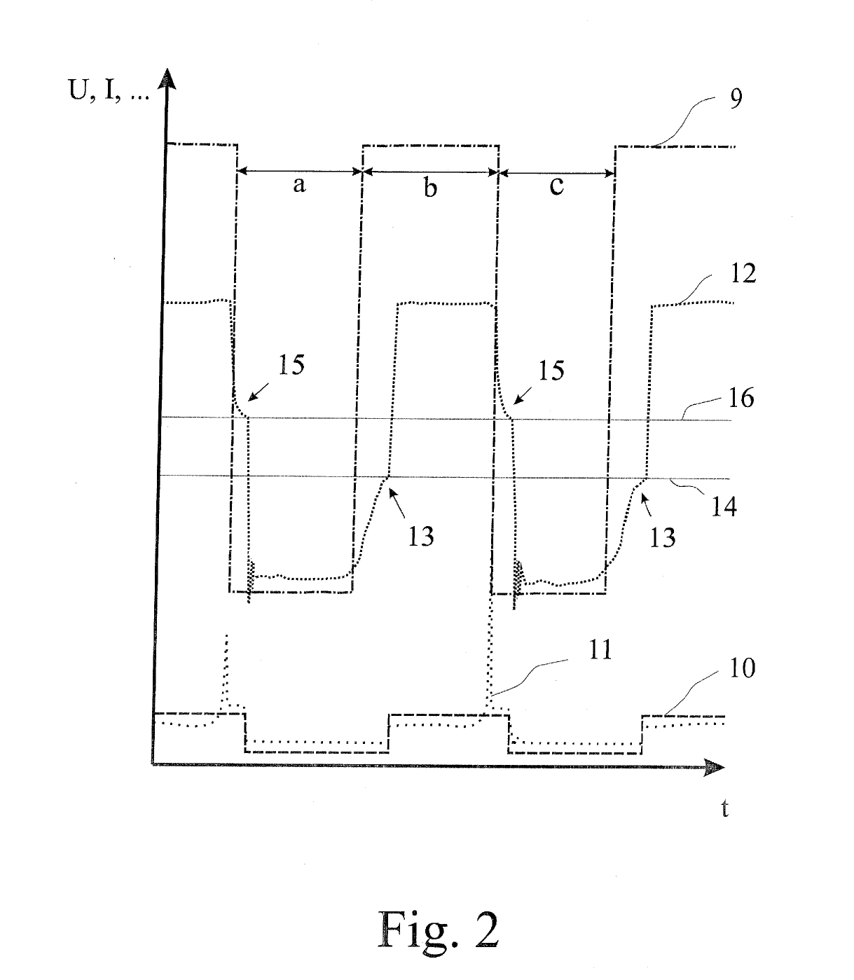

FIG. 2 shows the temporal profile of electrode current and electrode voltage and of further variables during the operation of the apparatus in accordance with FIG. 1.

The apparatus illustrated in FIG. 1 shows very schematically how the method in accordance with the proposal proceeds by way of example. The method serves for the electrostatic charging particularly of surfaces of non-conducting objects 1. In the exemplary embodiment illustrated, the objects 1 comprise chipboards with a laminate layer 2 placed thereon. The laminate layer 2 is intended to be laminated onto the chipboard by means of a laminating apparatus. In order to ensure a first fixing of the laminate layer 2 on the chipboard, electrostatic charging of the surface of the laminate layer 2 is provided.

For the above electrostatic charging, an electrode 4 is provided, to which high voltage relative to ground 6 or a counterelectrode is applied in the manner of a corona ionizer by means of a control device 5a. Here the voltage is preferably in the kV range, and the current is preferably in the mA range.

The objects 1 to be electrostatically charged are brought as necessary into the effective range 7 of the electrode 4. Here and preferably the situation is such that the objects 1 are moved into or through the effective range 7 of the electrode 4 by means of a conveying device, in particular a belt-type conveying device. In principle, however, it can also be provided that the electrode 4, rather than the respective object 1, is correspondingly moved.

Here and preferably only a single electrode 4 is illustrated. However, it is also conceivable for a plurality of electrodes 4 to be provided, which correspondingly interact with ground 6 or at least one counterelectrode. In particular, is preferably provided that at least two electrodes 4 are arranged one behind another in the object movement direction 8. The extent of the effective range 7 can thus be enlarged, which may be advantageous in a manner yet to be explained. Hereinafter mention is only ever made of one electrode 4. These explanations correspondingly apply to an arrangement composed of a plurality of electrodes 4.

The control device 5a here is part of an electrical or electronic assembly 5 that also contains, alongside the control device 5a, the components 5b required for generating the high voltage.

Upon movement of the objects 1 to be electrostatically charged in the object movement direction 8, toward the left in FIG. 1, the objects 1 pass through the effective range 7 of the electrode 4. In this case, the only loosely lying laminate layer 2 is electrostatically charged, thus resulting in a force of attraction between the laminate layer 2 and the to object 1 moreover. As a result, the laminate layer 2 by virtue of the charging nestles against the object 1 moreover, as can be discerned in FIGS. 1b) and c) for the object 1 respectively illustrated at the outer left.

FIG. 1a) shows idling operation, wherein no object 1 to be electrostatically charged is present in the effective range 7 of the electrode 4. In this case, the control device 5a is transferred into an idling state in which an idling current is impressed into the electrode 4. Upon further movement of the objects 1 in the conveying direction 8, the object 1 closest to the electrode 4 passes into the effective range 7 of the electrode 4, as a result of which the control device 5a is transferred into a charging state (FIG. 1b)). In this charging state, a charging current different from the idling current is impressed into the electrode 4 by means of the control device 5a.

The absolute value of the charging current is expediently greater than the absolute value of the idling current, with the result that wear and energy consumption are reduced in idling operation. In a particularly preferred configuration, the absolute value of the charging current is even a multiple of, in particular at least five times, the absolute value of the idling current. Other design variants are conceivable.

FIG. 1c) finally shows the state after a charged object 1 has just left the effective range 7 of the electrode 4. As a result, the control device 5a is transferred into the idling state again.

In FIG. 2 the idling operation in accordance with FIG. 1a) is identified by the reference symbol “a”, the charging operation in accordance with FIG. 1b) is identified by the reference symbol “b” and the subsequent idling operation in accordance with FIG. 1c) is identified by the reference symbol “c”.

The occupancy curve of the effective range 7 of the electrode 4 with objects 1 is identified by the reference symbol “9” in FIG. 2. The minimum value of the occupancy 9 means that no object 1 is situated in the effective range 7 of the electrode 4. Correspondingly, the maximum value of the occupancy curve 9 means that an object 1 is situated in the effective range 7 of the electrode 4.

The reference variable of the control device 5a, that is to say the desired electrode current, is identified with the reference symbol 10 in FIG. 2. It can be gathered from the illustration in accordance with FIG. 2 that the desired electrode current 10 (in each case with a delay yet to be explained) is reduced to a minimum value in idling operation a and is increased to a maximum value in charging operation b. The minimum value of the desired electrode current 10 is accordingly the above idling current, while the maximum value of the desired electrode current 10 is the charging current. The resulting actual electrode current is provided with the reference symbol “11” in the illustration in accordance with FIG. 2.

Various possibilities are conceivable for the above transfer of the control device 5a into the idling state or into the charging state. Here and preferably the electrode 4 itself is utilized in the manner of a sensor for detecting an object 1 in the effective range 7. Preferably, a trigger device 5c is provided for this purpose, by means of which trigger device the control device 5a is transferred into the idling state or into the charging state in a manner dependent on the electrode voltage, which is illustrated with the reference symbol “12” in FIG. 2. The trigger device 5c and the control device 5a are preferably combined in terms of hardware technology, and are only realized separately in terms of software technology.

In a particularly preferred configuration, when an object 1 to be electrostatically charged enters into the effective range 7 of the electrode 4, the control device 5a is transferred into the charging state by means of the trigger device 5c while when a charged object 1 exits from the effective range 7 of the electrode 4, the control device 5a is transferred into the idling state by means of the trigger device 5c. Upon transition from the situation in accordance with FIG. 1a) into the situation in accordance with FIG. 1b), the control device 5a is therefore transferred from the idling state into the charging state. Upon transition from the situation in accordance with FIG. 1b) into the situation in accordance with FIG. 1c) the control device 5a is then transferred into the idling state again.

Upon transition from the situation in accordance with FIG. 1a) into the situation in accordance with FIG. 1b), that is to say the transition from idling operation a into charging operation b in accordance with FIG. 2, an absolute rise in the electrode voltage 12 can be noted since this is associated with an increase in the electrical resistance between the electrode 4 and the counterelectrode or ground and the control device 5a attempts to maintain the desired electrode current 10, here the idling current.

The above rise 13 in the electrode voltage 12 is identified by the reference symbol “13” in FIG. 2. This rise in the electrode voltage 12 can be utilized for detecting an object 1. Here and preferably an absolute rise in the electrode voltage 12 above an idling threshold voltage 14 by means of the trigger device 5c brings about the transfer of the control device 5a into the charging state. This means that the desired electrode current 10 is raised to the level of the charging current when the idling threshold voltage 14 is reached. This is in turn effected by the electrode voltage 12 being correspondingly raised, here to the maximum value illustrated in FIG. 2. It should be pointed out for clarification that the control device 5a as explained above, operates as current control, even if a virtually constant value is established here for the electrode voltage 12.

The transfer of the control device 5a from the charging state into the idling state is preferably also provided in a corresponding manner. This corresponds to the transition from the situation illustrated in FIG. 1b) into the situation illustrated in FIG. 1c), and correspondingly the transition from charging operation b into idling operation c in accordance with FIG. 2. The exiting of the object 1 from the effective range 7 firstly brings about a rise in the actual electrode current 11 as a result of the reduction of the resistance between the electrode 4 and the counterelectrode or ground 6. The control device 5a counteracts this rise in the actual electrode current 11 with a reduction of the electrode voltage 12. The resulting fall in the electrode voltage 12 is provided with the reference symbol “15” in FIG. 2. From the charging state, an absolute fall in the electrode voltage 12 below a charging threshold voltage 16 by means of the trigger device 5c then brings about the transfer of the control device 5a into the idling state. The desired electrode current 10 is correspondingly reduced to the level of the idling current.

It should be pointed out that here and preferably in each case the absolute rise or fall in the electrode voltage 12 has been taken as a basis by the trigger device 5c in determining the respective trigger event. However, in both cases it is also conceivable for the respective trigger event to be a relative rise in the electrode voltage 12 by an idling threshold portion or the relative fall in the electrode voltage 12 by a charging threshold portion.

A certain temporal delay with regard to the reaction to an object 1 entering into the effective range 7 and to an object 1 exiting from the effective range 7 is inherent to the sensor for detecting an object 1, said sensor being formed from the electrode 4 as explained above. The transfer of the control device 5a into the charging state or into the idling state is therefore always concluded with a certain delay.

It is therefore advantageously provided that the extent of the effective range 7 of the electrode 4 in the object movement direction 8, the object movement speed and the switching behavior of trigger device 5c and control device 5a are coordinated with one another such that, when an object 1 enters into the effective range 7 of the electrode 4, the transfer of the control device 5a into the charging state is concluded before a region of the respective object 1 that is to be electrostatically charged actually exits again from the effective range 7 of the electrode 4. Specifically, this avoids the situation in which the leading region of the object 1 in the object movement direction 8 is omitted during the charging process because it has already long since left the effective range 7 of the electrode 4 at the instant of the setting of charging operation.

In principle the extent of the effective range 7 of the electrodes 4 in the object movement direction 8 can also be enlarged in order to avoid the situation where the leading region of the object 1 is omitted during charging. One possibility consists, as explained above, in at least two electrodes 4 being arranged one behind another in the object movement direction in such a way that the individual effective ranges 7 complement one another to form an effective range having an enlarged extent in the object movement direction 8. In this case, electrodes 4 of different types and sizes can be combined with one another in order to optimally design the resulting effective range.

An electrode 4 can be configured as an electrode rod and have, if appropriate a multiplicity of electrode tips arranged in a manner distributed over the electrode rod. The electrode rod preferably extends substantially perpendicularly to the object movement direction 8. For the case where a plurality of electrodes 4 are provided, in order to enlarge the effective range 7, the electrode rods are preferably arranged parallel to one another and at a distance from one another in the movement direction.

In principle it is conceivable for the idling current impressed into the electrode 4 and/or the charging current impressed into the electrode 4 to be variable, in particular adapted to the respective boundary conditions, during idling operation and/or charging operation. Here and preferably the situation is such, however, that both the idling current impressed into the electrode 4 and the charging current impressed into the electrode 4 are substantially constant over the idling operation and charging operation.

According to a further teaching, which is likewise accorded independent importance, a method for electrostatic charging of non-conducting objects 1 by means of at least one electrode 4 is claimed. High voltage relative to ground 6 or a counterelectrode is applied to the electrode 4 by means of a control device 5a in the above manner. As above, the object 1 to be electrostatically charged is brought as necessary into the effective range 7 of the electrode 4.

What is essential here as well is that the control device 5a is transferred into an idling state if no object to be electrostatically charged is present in the effective range 7 of the electrode 4, and that the control device 5a is transferred into a charging state if an object 1 to be electrostatically charged is present in the effective range 7 of the electrode 4.

What is furthermore essential towards this further teaching is that a predetermined temporal deviation in control operation, in particular a predetermined temporal deviation of the manipulated variable of the control device 5a, is detected by means of a trigger device 5c, wherein the control device 5a is transferred into the idling state or the charging state by means of the trigger device 5c in a manner dependent on this detection.

The further teaching therefore relates to a method in which the electrode 4 is utilized as a sensor for detecting an object 1 in the manner indicated further above. However, providing current control is not absolutely necessary for this further teaching.

According to a further teaching, which is likewise accorded independent importance, an apparatus for carrying out one of the methods proposed is claimed. Reference should be made to all explanations concerning the methods in accordance with the proposal, insofar as they are suitable for describing the resulting apparatus.

1. A method for electrostatic charging of non-conducting objects by means of at least one electrode, to which high voltage relative to ground or at least one counterelectrode is applied for this purpose in the manner of a corona ionizer by means of a control device, wherein an object to be electrostatically charged is brought as necessary into the effective range of the electrode,
wherein
the control device operates as current control, in that the control device (5a) is transferred into an idling state if no object to be electrostatically charged is present in the effective range of the electrode, and in that, in the idling state, an idling current is impressed into the electrode, in that the control device is transferred into a charging state if an object to be electrostatically charged is brought into the effective range of the electrode, and in that, in the charging state, a charging current different than the idling current is impressed into the electrode by means of the control device (5a).

2. The method as claimed in claim 1, wherein the absolute value of the charging current is greater than the absolute value of the idling current, preferably in that the absolute value of the charging current is a multiple of the absolute value of the idling current, more preferably in that the absolute value of the charging current is at least five times the absolute value of the idling current.

3. The method as claimed in claim 1, wherein the control device is transferred into the idling state or into the charging state by means of a trigger device in a manner dependent on the electrode voltage.

4. The method as claimed in claim 3, wherein, when an object to be electrostatically charged enters into the effective range of the electrode, the control device is transferred into the charging state by means of the trigger device and in that, when a charged object exits from the effective range of the electrode, a control device is transferred into the idling state by means of the trigger device.

5. The method as claimed in claim 3, wherein, from the idling state, an absolute rise in the electrode voltage above an idling threshold voltage or a relative rise in the electrode voltage by an idling threshold portion brings about the transfer of the control device into the charging state by means of the trigger device.

6. The method as claimed in claim 3, wherein, from the charging state, an absolute fall in the electrode voltage below a charging threshold voltage or a relative fall in the electrode voltage by a charging threshold portion brings about the transfer of the control device into the idling state by means of the trigger device.

7. The method as claimed in claim 1, wherein the extent of the effective range of the electrode in the object movement direction, the object movement speed and the switching behavior of trigger device and control device are coordinated with one another such that, when an object enters into the effective range of the electrode, the transfer of the control device into the charging state is concluded before a region of the respective object actually exits again from the effective range of the electrode.

8. The method as claimed in claim 1, wherein at least two electrodes are arranged one behind another in the object movement direction and an object to be electrostatically charged is brought as necessary into the resulting effective range of the electrodes.

9. A method for electrostatic charging of non-conducting objects by means of at least one electrode, to which high voltage relative to ground or at least one counterelectrode is applied for this purpose by means of a control device, wherein an object to be electrostatically charged is brought as necessary into the effective range of the electrode,
wherein
the control is transferred into an idling state if no object to be electrostatically charged is present in the effective range of the electrode and in that the control device is transferred into a charging state if an object to be electrostatically charged is brought into the effective range of the electrode, in that a predetermined temporal deviation in control operation, in particular a predetermined temporal deviation of the manipulated variable of the control device, is detected by means of a trigger device, and in that the control device is transferred into the idling state or the charging state by means of the trigger device in a manner dependent on this detection.

10. An apparatus for electrostatic charging of non-conducting objects by means of at least one electrode, to which high voltage relative to ground or at least one counterelectrode can be applied for this purpose in the manner of a corona ionizer by means of a control device, wherein an object to be electrostatically charged can be brought as necessary into the effective range of the electrode,
preferably for carrying out a method as claimed in claim 1,
wherein
the arrangement is implemented such that the control device operates as current control, in that the control device is transferred into an idling state if no object to be electrostatically charged is present in the effective range of the electrode, and in that, in the idling state, an idling current is impressed into the electrode, in that the control device is transferred into a charging state if an object to be electrostatically charged is brought into the effective range of the electrode, and in that, in the charging state, a charging current different than the idling current is impressed into the electrode by means of the control device,
or
in that the arrangement is implemented such that the control device is transferred into an idling state if no object to be electrostatically charged is present in the effective range of the electrode and in that the control device is transferred into a charging state if an object to be electrostatically charged is brought into the effective range of the electrode, in that a predetermined temporal deviation in control operation, in particular a predetermined temporal deviation of the manipulated variable of the control device, is detected by means of a trigger device, and in that the control device is transferred into the idling state or the charging state by means of the trigger device in a manner dependent on this detection.
